(19) United States
(12) Patent Application Publication
(10) Pub. No.: US 2009/0152211 A1
(43) Pub. Date: Jun. 18, 2009

(54) Hot water sterilization of water filtration beds

(75) Inventors: George J. Crits, Ardmore, PA (US); William J. Runyan, West Chester, PA (US)

Correspondence Address: William J. Runyan, 24 Hagerty Blvd., West Chester, PA, 19382, US

(73) Assignee: Idrecousa, Ltd., West Chester, PA (US)

(21) Appl. No.: 12/001,275

(22) Filed: Dec. 12, 2007

(51) Int. Cl. B01D 35/18

(52) U.S. Cl. 210/774; 210/792; 210/793; 210/185; 210/186

(57) ABSTRACT

Hot Water Sterilization of Activated Carbon beds or other adsorbents in filter tanks by including an electric or steam heating coil in the tank, alternately in the gravel underdrains, or in a plenum underdrain, or in an external canister.

### BRIEF DESCRIPTION OF THE INVENTION

Hot Water Sterilization of Activated Carbon beds or other adsorbents in filter tanks by including a electric or steam heating coil in the tank, alternately in the gravel underdrains, or in a plenum underdrain, or in an external canister.

### BACKGROUND OF THE INVENTION

Activated carbon beds and other adsorbents in the industrial and household water operating filter tanks have in short time developed slimes and bacteria in the lower parts of the bed because the chlorine or other oxidizing agents (such as Chlorine, Chlorine Dioxide, or Ozone, etc. which is necessary to keep the water sterile) in the influent water are removed in the upper layers of these beds. Therefore, there is a neutral climate or septic condition in the lower parts of the beds or tanks in which slime and bacteria will grow, accumulate, and proliferate since no oxidants are present here.

It is well known in industry: These large activated carbon tanks (18″ Dia. & above) are regularly sterilized by applying steam to the beds, exit piping, and tank walls. Steam is added for several hours depending the severity of the fouling to sterilize the tank. The tank is usually drained of water and steam added to the top or to the bottom of the tank and continued for until the tank is fully heated above 210′ F and continued for at least 1 or 2 hours. Finally the tank is backwashed by the usual service water.

### BRIEF SUMMARY OF THE INVENTION

For many household “point of use” water filter systems, the exit end of these filters have bacteria and slime growing there, when activated carbon, alumina, titanium, or other media is used to treat the water and the chlorine, ozone, or other oxidant is invariably removed by the inlet layers. These must be replaced often or hot water sterilized regularly. Many ignore the need for this process of sterilization and are plagued with higher bacteria in the treated water from these. However, along with industrial units, small household activated carbon tanks and other granular or zeolite beds are also subject to sliming and accumulation of bacteria for the same reasons listed above. These small tanks generally measure 6″ to 24″ in diameter and are 3 to 7 ft. high, and are pictured in FIGS. 1,2,3, and 4

### DESCRIPTION OF THE DRAWINGS

FIG. 1 shows a typical tank 2 in which is a bed of filter media 3 with the bottom underdrain layers containing large gravels 4 in which the heating coil may be added. Electric operated solenoids 13 and 14 or manual valves 17 and 18 are used to supply from household 16 a small hot water flow. Timer controller 12 starts & stops the process. The underdrain collection piping is usually based on ¼″ holes or slots in the laterals, small enough to retain the gravels.

FIG. 2, a similar tank as in FIG. 1 but with the underdrain based on a flat perforated plate 5 or with strainer nozzles screwed into a plate, under which a heating coil 7 may be installed.

FIG. 3, a similar tank as in FIG. 1 but with an underdrain collection piping based on slotted or screened laterals 6 to retain the filter media without use of gravels. This tank is full of filter media 3. In this case, an external canister with the heating coil 9 may be used to supply the hot water to the bottom or to the top of the tank. These tanks may be modified by adding coarse gravels and resorting to adding the heating coil in the gravels as in FIG. 1

FIG. 4, a similar tank as in the other figures but with the heating coil 11 added in the freeboard or headroom at the top of the tank. The heating coil 11 may be added with any of the above mentioned filter arrangements, those with underdrain assemblies using graded gravels 4 or without gravels.

### DETAILED DESCRIPTION OF THE INVENTION

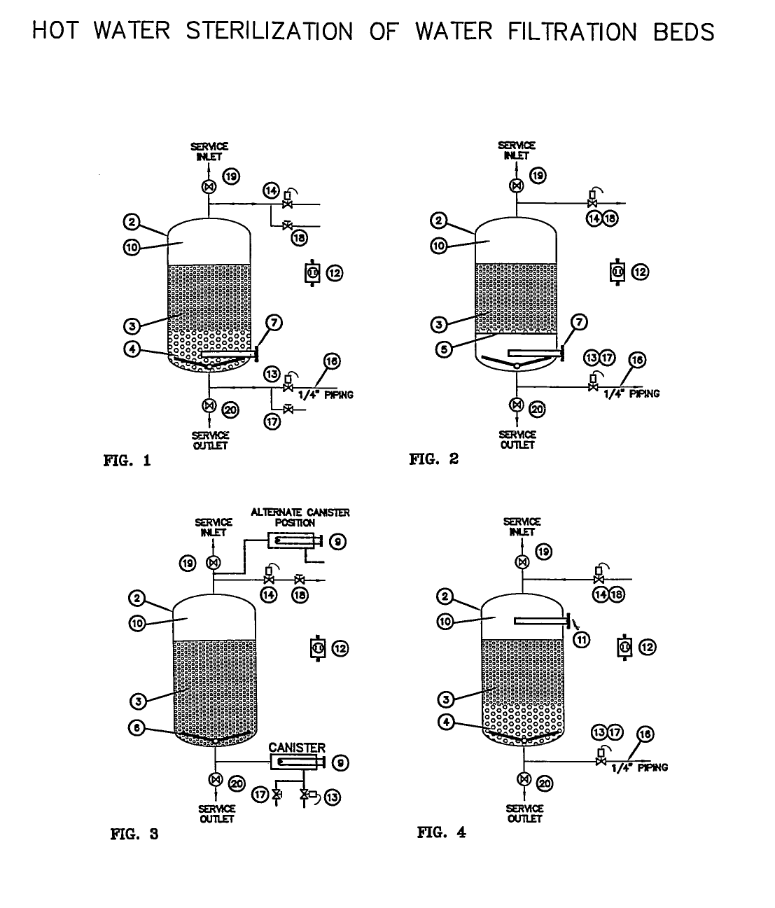

All household or small industrial filters should have this process of regular hot water (180′ F+) sterilizations to avoid buildup of bacteria or slimes in the exit areas of these. As shown in FIG. 1, In the case of filters with gravels in the underdrains, an electric heating coil 7 may be placed in the lower coarse gravel layers 4. With the tanks with a porous or perforated underdrain plate 5, the heating coil 7 may be placed under the plate as shown in FIG. 2

As shown in FIG. 3, with tanks full of filter material with underdrain using slotted or screened effluent collection piping, and with no gravels, a separate small heating “canister” 9 is added in the effluent external piping, or alternately the canister may be directing hot water into the top of the filter. With any of these filter arrangements or designs, the heating element may be elected to be simply placed in the freeboard 10 as shown in FIG. 4, in the upper portion of the tank, above the filter bed. Heating in this way may take a little longer to reach the temperature at the bottom of the tank.

The heating element 7 in the gravels, if electric may be of reduced wattage or voltage (or a 220 v. heater may be operated at 110 v.) and household hot water is applied as is done with dish washing machines. For the installation of the electric heating element in the top of the tank, 10, the electric element 11 may be a normal 110 v. or 220 v. element.

For automatic operations, a timer clock controller 12 is utilized to select an appropriate time and duration such at late night to implement the hot water sterilization. The filter is taken out of service, by closing valves 19 and 20 and need not be drained, and an electric solenoid valve 13 opens at this time to supply the normal household hot water to the bottom heating element and another valve 14 opens at the top of the tank to vent the spent hot water. For alternate down flow application, the hot water will be introduced into the top of the tank 10 and heated additionally by electric or steam element 11 as shown in FIG. 4. In downflow application, the influent or hot water is applied at the top through the small electric solenoid valve 14 and the spent or waste hot water is removed from the bottom of the tank with a small electric solenoid valve 13. For small tanks, the influent or hot water source might be with the use of a ¼″ copper or plastic tubing 16 from the hot water source in household plumbing and assembled as is done with water to an ice maker. The hot water may be applied for 1 to 3 hours starting at mid-night and then stopped so that the unit cools for next day service or operation. A thermostat or thermometer may be used to control the heating, although the heating may take place without thermostat when the electrical coil is sized just enough to reach the maximum temperature of 180′ F or higher. Also it is important to have the small hot water flow begin before or quickly on starting the heating coil in the gravels, because the electric heating element may over heat and burn out.

With manual operation, the procedure may be done using an electric switch and small ¼″ hand valves 17 & 18, instead of the electric solenoid valves. For example, the procedure for the manual operation of a filter assembly with the heating element at the bottom will proceed with the following steps: The inlet water supply valve 19 and the outlet valve 20 are closed to isolate the filter from service. The tank need not be drained. Hand valve 17 is opened to introduce the small household hot water flow to the bottom of the tank and hand valve 18 is opened at the top to vent or to allow displacement of the cold water from the tank. The switch is operated to turn on the electric current to the heater. Depending on the electric heating coil rating, the heating may take a an hour or more to heat the tank to above 180′ F and the heating is continued for hours as required to sterilize the media in the tank. Afterwards, the heating is stopped and the valves 17, 18 are closed and the tank may set to cool or the tank may be placed in service or in rinse mode to displace the hot water. In automatic operation, all of the above procedures will be done by an electrical timer or controller 12 and electric operated valves 13, 14.

1. We claim in small filter tanks, the application of an electric heating element within or external of the tank to produce hot water to sanitize or sterilize the filter media at the exit end of these tanks to undo sliming and bacteria buildup.

2. In the application of claim 1, where the heating element is added within the coarse gravels in the underdrain assembly at the bottom of the tank.

3. In the application of claim 1, to sanitize or sterilize the filter media lying on a porous or perforated plate by placing an heating element under these in the exit end of the filter tank for upflow sterilization operation.

4. In the application of claim 1, where the heating element is added in an external canister to provide hot water either to the exit end of the tank or to the inlet of the tank for upflow hot water sterilization or downflow hot water sterilization.

5. (canceled)

6. In the application of claim 1, where the heating element is added within the freeboard or top headroom of the tank for down flow sterilization.
